(19) United States
(12) Patent Application Publication
(10) Pub. No.: US 2025/0216297 A1
(43) Pub. Date: Jul. 3, 2025

(54) SEMICONDUCTOR PROCESS MEASUREMENT SYSTEM AND SEMICONDUCTOR PROCESS MEASUREMENT METHOD

(71) Applicant: Samsung Electronics Co., Ltd., Suwon-si (KR)

(72) Inventors: Chang Ho LEE, Suwon-si (KR); Tae Soo KIM, Suwon-si (KR); Young Hoon KIM, Suwon-si (KR); Jae Yong PARK, Suwon-si (KR)

(21) Appl. No.: 18/944,409

(22) Filed: Nov. 12, 2024

(30) Foreign Application Priority Data
Jan. 2, 2024 (KR) 10-2024-0000067

(51) Int. Cl. G01M 99/00; G06N 3/0455; G06N 3/0985; H01L 21/67

(52) U.S. Cl. CPC G01M 99/005; G06N 3/0455; G06N 3/0985; H01L 21/67253

(57) ABSTRACT

A semiconductor manufacturing process measurement system and a semiconductor manufacturing process measurement method are provided. The semiconductor manufacturing process measurement system includes a memory; and a processor configured to execute a program stored in the memory, wherein the program is configured to be executed by the processor to cause the semiconductor manufacturing process measurement system: collect data from a semiconductor manufacturing apparatus; preprocess the data in consideration of characteristics of the semiconductor manufacturing apparatus; acquire an estimated measurement value using DNN (Deep Neural Network); and detect a trend of the estimated measurement value over time, and determine a contribution of the data based on the trend.

### CROSS-REFERENCE TO RELATED APPLICATION

This application claims priority from Korean Patent Application No. 10-2024-0000067 filed on Jan. 2, 2024, in the Korean Intellectual Property Office, and all the benefits accruing therefrom under 35 U.S.C. 119, the contents of which in its entirety are herein incorporated by reference.

### BACKGROUND

### Field

The present disclosure relates to a semiconductor manufacturing process measurement system and a semiconductor manufacturing process measurement method.

### Description of Related Art

A semiconductor device is manufactured through various processes. As semiconductor device design technology develops, the number of processes for manufacturing the semiconductor device increases and complexity of each of the processes increases.

Accordingly, in the semiconductor manufacturing process with a long turn around time (TAT), the need to implement more immediate management in response to an outlier and secure a stable yield in each process is increasing.

To this end, it is important to accurately estimate measurement values, based on characteristics of the semiconductor manufacturing process, and to identify a factor affecting the measurement values when the outlier occurs.

### SUMMARY

A technical purpose of the present disclosure is to provide a semiconductor manufacturing process measurement system with improved reliability.

A technical purpose of the present disclosure is to provide a semiconductor manufacturing process measurement method with improved reliability.

The technical purposes of the present disclosure are not limited to the technical purposes as mentioned above, and other technical purposes as not mentioned will be clearly understood by those skilled in the art from following descriptions.

A semiconductor manufacturing process measurement system according to some embodiments of the present disclosure to achieve the above technical purpose includes: a memory; and a processor configured to execute a program stored in the memory, wherein the program is configured to be executed by the processor to cause the semiconductor manufacturing process measurement system: collect data from a semiconductor manufacturing apparatus; preprocess the data in consideration of characteristics of the semiconductor manufacturing apparatus; acquire an estimated measurement value using DNN (Deep Neural Network); and detect a trend of the estimated measurement value over time, and determine a contribution of the data based on the trend.

A semiconductor manufacturing process measurement system according to some embodiments of the present disclosure to achieve the above technical purpose includes: a memory; and a processor configured to execute a program stored in the memory, wherein the program is configured to be executed by the processor to cause the semiconductor manufacturing process measurement system: collect data measured by a sensor of a semiconductor manufacturing apparatus therefrom; preprocess the data in consideration of characteristics of the semiconductor manufacturing apparatus; acquire an estimated measurement value using DNN (Deep Neural Network); and detect a trend of the estimated measurement value over time, and determine a contribution of the data based on the trend, wherein the preprocessing, by the processor, of the data includes: performing, by the processor, normalization of the data; processing, by the processor, missing data corresponding to the data using an autoencoder; and selecting, by the processor, key data from among the data.

A semiconductor manufacturing process measurement system according to some embodiments of the present disclosure to achieve the above technical purpose includes: a memory; and a processor configured to execute a program stored in the memory, wherein the program is configured to be executed by the processor to cause the semiconductor manufacturing process measurement system: collect data measured from a semiconductor manufacturing apparatus; perform normalization of the data in consideration of characteristics of the semiconductor manufacturing apparatus; acquire an estimated substitute value for missing data corresponding to the data using an autoencoder; select key data from the data based on a correlation between semiconductor manufacturing processes; acquire an estimated measurement value using DNN (Deep Neural Network); and detect an abnormal trend of the estimated measurement value over time and determining a contribution of the data based on the abnormal trend.

Specific details of other embodiments are included in the detailed description and drawings.

### BRIEF DESCRIPTION OF DRAWINGS

The above and other aspects and features of the present disclosure will become more apparent by describing in detail some embodiments thereof with reference to the attached drawings, in which:

FIG. 1 is a block diagram illustrating a semiconductor manufacturing process measurement system according to some embodiments;

FIG. 2 is a diagram illustrating an operation performed by a data collection module according to some embodiments;

FIG. 3 is a diagram illustrating a data preprocessing module according to some embodiments;

FIG. 4 and FIG. 5 are diagrams illustrating an operation performed by a data normalization module according to some embodiments;

FIG. 6 is a diagram illustrating an operation performed by a missing data processing module according to some embodiments;

FIG. 7 and FIG. 8 are diagrams illustrating an operation performed by a data selection module according to some embodiments;

FIG. 9 is a diagram illustrating an operation performed by a measurement value estimating module according to some embodiments;

FIG. 10 is a diagram illustrating a contribution analysis module according to some embodiments;

FIGS. 11 to 13 are diagrams illustrating an operation performed by a contribution analysis module according to some embodiments; and

FIG. 14 is a flowchart illustrating a semiconductor manufacturing process measurement method according to some embodiments.

### DETAILED DESCRIPTIONS

Advantages and features of the present disclosure, and a method of achieving the advantages and features will become apparent with reference to embodiments described later in detail together with the accompanying drawings. However, embodiments of the present disclosure are not limited to the embodiments as disclosed herein but may be implemented in various different forms. Thus, these embodiments are set forth to make the disclosure complete to those of ordinary skill in the technical field to which the disclosure belongs. The scope of the inventive concept represented by these embodiments is only defined by the scope of the claims.

The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the inventive concept. However, it will be understood that the inventive concept may be practiced without these specific details. In other instances, well-known methods, procedures, components, and circuits may not have been described in detail so as not to unnecessarily obscure aspects of the inventive concept. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the inventive concept as defined by the appended claims.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements indicates requiring at least one of the elements in the list, rather than requiring at least one element of each of the elements in the list. In interpretation of numerical values, an error or tolerance therein may occur even when there is no explicit description thereof.

It will be understood that when an element or layer is referred to as being “connected to”, or “coupled to” another element or layer, it may be directly connected to or coupled to another element or layer, or one or more intervening elements or layers therebetween may be present. In addition, it will also be understood that when an element or layer is referred to as being “between” two elements or layers, it may be the only element or layer between the two elements or layers, or one or more intervening elements or layers therebetween may also be present.

In descriptions of temporal relationships, for example, temporal precedent relationships between two events such as “after”, “subsequent to”, “before”, etc., another event may occur therebetween unless “directly after”, “directly subsequent” or “directly before” is not indicated.

When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the ordinal terms “first”, “second”, “third”, and so on may be used herein to describe various elements, components, regions, layers and/or sections, these elements, components, regions, layers and/or sections should not be limited by these ordinal terms. These ordinal terms are used to distinguish one element, component, region, layer or section from another element, component, region, layer or section that may otherwise have the same common name. Thus, a first element, component, region, layer or section described in a first location of the specification or claims may be termed a second element, component, region, layer or section in a second location of the specification or claims, without departing from the spirit and scope of the present disclosure.

The features of the various embodiments of the present disclosure may be partially or entirely combined with each other and may be technically associated with each other or operate with each other. The embodiments may be implemented independently of each other and may be implemented together in an association relationship.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

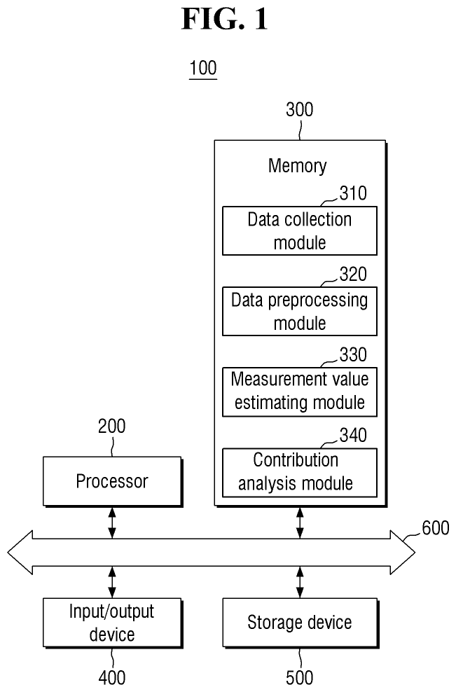

FIG. 1 is a block diagram for illustrating a semiconductor manufacturing process measurement system according to some embodiments.

Referring to FIG. 1, a semiconductor manufacturing process measurement system 100 according to some embodiments may include a processor 200, a memory 300, an input/output device 400, a storage device 500, and a bus 600. The semiconductor manufacturing process measurement system 100 may be embodied as an integrated device, for example. The semiconductor manufacturing process measurement system 100 may be embodied, for example, as a dedicated device for measuring a value of an attribute of a semiconductor manufacturing process. For example, the semiconductor manufacturing process measurement system 100 may be a computer that implements various modules to measure the target value of the semiconductor manufacturing process.

The processor 200 may control the semiconductor manufacturing process measurement system 100. The processor 200 may execute instructions in the form of an operating system, firmware, etc. to operate the semiconductor manufacturing process measurement system 100.

The processor 200 may include a core capable of executing processor instructions, such as a microprocessor, an application processor (AP), a digital signal processor (DSP), and a graphic processing unit (GPU).

The processor 200 may communicate with the memory 300, the input/output device 400, and the storage device 500 through the bus 600. The processor 200 may collect data measured from a semiconductor manufacturing apparatus by operating a data collection module 310 loaded into the memory 300. The processor 200 may perform normalization on the data, acquire an estimated substitute value for missing data corresponding to the data, and select key data of the data using a data preprocessing module 320 loaded into the memory 300. The processor 200 may acquire an estimated measurement value using a measurement value estimating module 330 loaded into the memory 300. The processor 200 may detect an abnormal trend over time on the estimated measurement value and determine a contribution of the data to the abnormal trend using the contribution analysis module 340 loaded in the memory 300.

Each of the data collection module 310, the data preprocessing module 320, the measurement value estimating module 330, and the contribution analysis module 340 may be embodied as a program or software module including a plurality of instructions executed by the processor 200 and may be stored in a computer-readable storage medium.

The memory 300 may store therein instructions for implementing the data collection module 310, the data preprocessing module 320, the measurement value estimating module 330, and the contribution analysis module 340. The data collection module 310, the data preprocessing module 320, measurement value estimating module 330, and the contribution analysis module 340 may be loaded, for example, from the storage device 500.

The memory 300 may be a volatile memory such as SRAM or DRAM, or a non-volatile memory such as PRAM, MRAM ReRAM, or FRAM NOR flash memory.

The input/output device 400 may control a user input to and a user output from user interface devices. For example, the input/output device 400 may include an input device such as a keyboard, a mouse, a touchpad, etc., and may receive various data. For example, the input/output device 400 may include an output device such as a display, a speaker, etc., and may output various data.

The storage device 500 may store therein various data related to the data collection module 310, the data preprocessing module 320, the measurement value estimating module 330, and the contribution analysis module 340. The storage device 500 may store therein code or software such as an operating system or firmware for execution by the processor 200.

The storage device 500 may include, for example, a memory card (MMC, eMMC, SD, MicroSD, etc.), a solid state drive (SSD), a hard disk drive (HDD), etc.

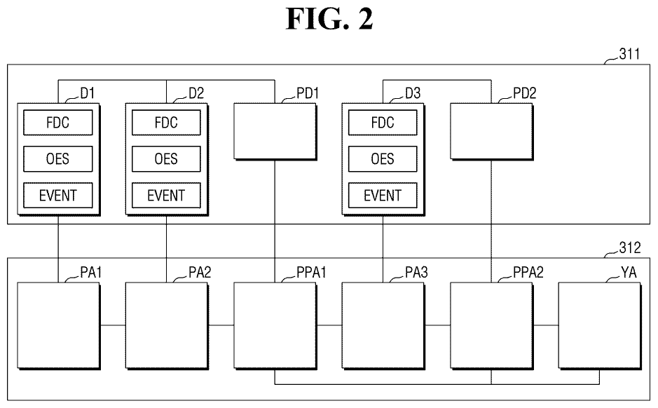

FIG. 2 is a diagram illustrating an operation performed by the data collection module according to some embodiments.

Referring to FIG. 1 and FIG. 2, the data collection module 310 may collect data 311 about semiconductor manufacturing processes from a semiconductor manufacturing apparatus 312 and perform processing on the collected data.

The semiconductor manufacturing apparatus 312 may include a first process apparatus PA1, a second process apparatus PA2, a first measurement apparatus PPA1, a third process apparatus PA3, a second measurement apparatus PPA2, and a yield estimating apparatus YA respectively used in manufacturing processes for manufacturing a semiconductor device.

The first measurement apparatus PPA1 may be used to measure a pattern formed through first and second semiconductor manufacturing processes respectively performed by the first and second process apparatuses PA1 and PA2. The second measurement apparatus PPA2 may be used to measure a pattern formed through a third semiconductor manufacturing process performed by the third process apparatus PA3.

The semiconductor manufacturing process data 311 may include first data D1 collected from the first process apparatus PA1, second data D2 collected from the second process apparatus PA2, and third data D3 collected from the third process apparatus PA3. The data collected from the process apparatuses may include process parameters such as process temperature, duration, pressure, or rate. Additionally, the data collected may include ambient information such as ambient temperature, humidity, and pressure. Other parameters and information are possible and are not limited to these examples. The semiconductor manufacturing process data 311 may include first measured pattern data PD1 collected from the first measurement apparatus PPA1 and second measured pattern data PD2 collected from the second measurement apparatus PPA2. A pattern may refer to a layer of material formed on a precursor to a semiconductor device, such as a substrate, and that is formed to have a particular geometry. Measured pattern data may include attributes of the pattern such as dimensions including thickness, width, length, or appearance. Other attributes are possible and are not limited to these examples.

In FIG. 2, it is shown that each of the first to third semiconductor manufacturing process data D1 to D3 includes only Fault Detection and Classification (FDC) sensor data FDC, optical emission spectroscopy (OES) apparatus measurement data OES, and wafer history data EVENT, which will be described later. However, types of the data collected from the first to third process apparatuses PA1 to PA3 are not limited thereto. Furthermore, the number of the semiconductor manufacturing processes, the number of the semiconductor manufacturing apparatus 312, and the number of the data 311 about the semiconductor manufacturing process according to embodiments are not limited to those shown in FIG. 2.

The semiconductor manufacturing process data 311 may include, for example, the FDC sensor data (FDC in FIG. 2), the wafer history data (EVENT in FIG. 2), and incoming measurement data.

The FDC sensor data (FDC in FIG. 2) may be raw data collected from a sensor of the semiconductor manufacturing apparatus 312, and the FDC sensor data may include quantitative data such as a temperature, a pressure, a RF power, etc. as measured by a sensor (not shown) connected to the semiconductor manufacturing apparatuses 312. The wafer history data (EVENT in FIG. 2) may be data related to loading/unloading of a wafer or other precursor into/from each semiconductor manufacturing apparatus 312, and the wafer history data may include data about change in a state of the wafer according to the loading/unloading. The incoming measurement data may include measurement values acquired in a preceding process that is used in or input to a subsequent process in a series of semiconductor manufacturing processes.

The semiconductor manufacturing process data 311 may be stored, represented by, or converted into a database in various forms depending on a purpose of use.

The semiconductor manufacturing process data 311 may include, for example, data on an apparatus in which the wafer is treated, data on a semiconductor manufacturing process recipe, data on a reticle of an apparatus used in a photo process, and/or data about a label of each thereof, but examples are not limited thereto.

Furthermore, the semiconductor manufacturing process data 311 may include statistical data generated based on raw data of a step that has a significant impact on measurements among steps of each process. For example, the statistical data may include an average or standard deviation value generated based on RF power for a specific time (such as 1 second or 10 seconds) rather than, or in addition to, each measured value of the RF power at a particular time.

Furthermore, the semiconductor manufacturing process data 311 may include overlay measurement data. Furthermore, the semiconductor manufacturing process data 311 may include, for example, data about a cleaning process as a pre/post treatment process before/after a main process such as an etching process. Furthermore, the semiconductor manufacturing process data 311 may include data related to an operation time of robots used in the semiconductor manufacturing apparatus 312. Furthermore, the semiconductor manufacturing process data 311 may include data on an optical spectrum acquired through an optical emission spectroscopy (OES) device (OES in FIG. 2) in a plasma treating process.

The data collection module 310 may associate the collected semiconductor manufacturing process data 311 to a wafer and thereby associate semiconductor manufacturing process data for the semiconductor manufacturing processes to each other using wafer-level ID information respectively stored in the semiconductor manufacturing process data 311. For example, using the above ID information, the data collection module 310 may know which semiconductor manufacturing apparatus 312 processed the wafer at a specific time.

Furthermore, the data collection module 310 may perform sensor aliasing using a mapping table. For example, with regard to FDC sensor data, names of sensors mapped to each wafer may be different from names of sensors mapped to other wafers, even when the wafers were processed in the same semiconductor manufacturing apparatus 312. Thus, the sensor aliasing may be performed such that the names of the sensors are unified into a single name using the mapping table.

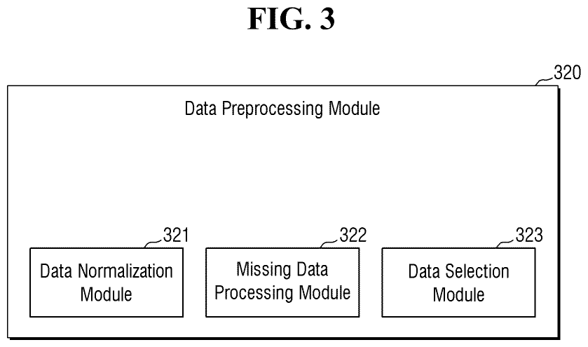

FIG. 3 is a diagram for illustrating a data preprocessing module according to some embodiments.

The data preprocessing module 320 may include a data normalization module 321, a missing data processing module 322, and a data selection module 323.

Predictive Maintenance (PM) cycles and operating environments of chambers of a semiconductor manufacturing apparatus 312 may differ in time, and individual chambers of a semiconductor manufacturing apparatus, or each semiconductor manufacturing apparatus may have PM cycles and operating environments that are different from each other. Accordingly, the FDC sensor data (FDC in FIG. 2) collected from the semiconductor manufacturing process may have a deviation due to the PM cycles and the changing operating environment. In particular, when PM has been performed, states in the chamber before and after the PM may be different from each other, and accordingly, a variation in an offset value (e.g., a value indicating a difference in terms of a chamber age) of the FDC sensor data (FDC in FIG. 2) may occur.

From this perspective, when a chamber has been subjected to PM, it may be desirable to consider the chamber as a completely new chamber from a data analysis perspective. For example, when a polishing pad used in a chemical mechanical polishing (CMP) process is replaced with a new polishing pad, the chamber may be considered a new chamber. Therefore, there is a need to perform normalization on the collected FDC sensor data (FDC in FIG. 2) in consideration of the PM cycle. In other words, it may be necessary to segment the collected FDC sensor data (FDC in FIG. 2) based on a PM time point. If the normalization had been performed on all FDC sensor data for every PM cycle, a chamber-to-chamber effect which represents a difference between unique offset values of chambers may be lost. Accordingly, there is a need to perform normalization on all of the FDC sensor data while considering the PM cycle.

The data normalization module 321 may extract data from a database in which a history of apparatus replacement and/or cleaning (maintenance) information is present. Accordingly, the data normalization module 321 may perform normalization on the FDC sensor data (FDC in FIG. 2) on a per PM cycle basis at a chamber level and may perform normalization thereon on a pr PM cycle basis at a sensor level. Accordingly, both wafer-to-wafer normalization in which the data normalization module 321 performs normalization on individual sensors on a chamber basis and chamber-to-chamber normalization in which the data normalization module 321 performs normalization on individual sensors without distinction between chambers may be considered.

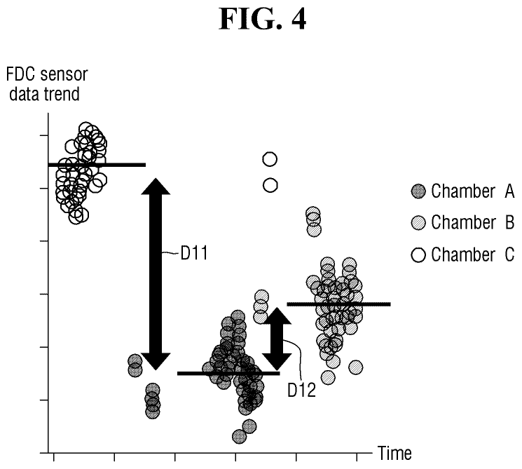

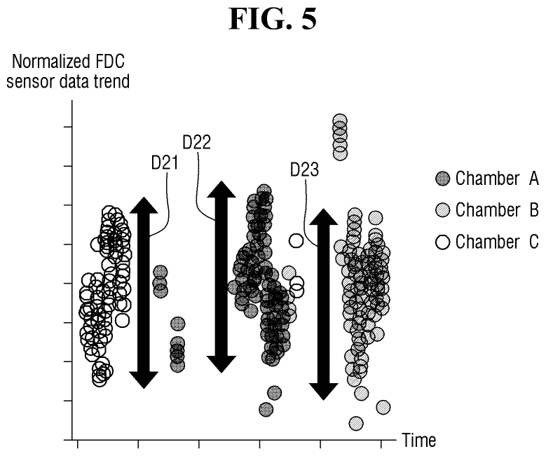

FIG. 4 and FIG. 5 are diagrams of sensor data trends and will be used for illustrating an operation performed by the data normalization module according to some embodiments. FIG. 4 is a diagram showing a trend of the FDC sensor data in each of three chambers, chamber A, chamber B, and chamber C. FIG. 5 is a diagram showing a trend of normalized entire FDC sensor data. Normalization of data refers to applying a transform function to the data so that each set of data has the same scale, which typically falls between 0 and 1. In one example, normalization may be performed for each data point by subtracting the minimum value of the data set from the value of the data point and dividing the result by the range of the data set. This normalization results in a normalized data set in which every value is between 0 and 1. Other techniques are possible and embodiments are not limited to this particular example.

Referring to FIG. 4, the data normalization module 321 may calculate differences D11 and D12 between the trends of the FDC sensor data of the chambers A, B and C. Referring to FIG. 5, differences D21, D22, and D23 between the FDC sensor data of wafers may be calculated by performing normalization on the trend of the entire FDC sensor data collected in each chamber on a per chamber basis.

The FDC sensor data (FDC in FIG. 2) may be transmitted and stored based on each of various components constituting the chamber. In some instances, the sensor data may have some missing values. When data having missing values is present, the missing data may be MCAR (Missing Completely at Random) or the missing data may be MNAR (Missing Not at Random). When missing data occurs simultaneously in multiple sensors it may be MNAR. For example, if a defect occurs in a specific component of the semiconductor manufacturing apparatus 312, the same result may be seen in each of the sensors that sense the component with the defect.

When processing data that includes a missing value, the data having the missing value may be processed based on an ensemble approach in consideration of inherent characteristics related to the missing data.

The missing data processing module 322 may acquire a substitute value (an imputation value) for the missing value based on a self-supervised Hadamard autoencoder (SS-HAE). In some examples, the missing data processing module 322 may apply the self-supervised Hadamard autoencoder (SS-HAE) to the data only on a per chamber basis to substitute the missing value. In this case, the missing data processing module 322 may process the data with the missing value by dividing the data into portions corresponding to the chambers and applying the self-supervised Hadamard autoencoder (SS-HAE) to each of the divided data portions.

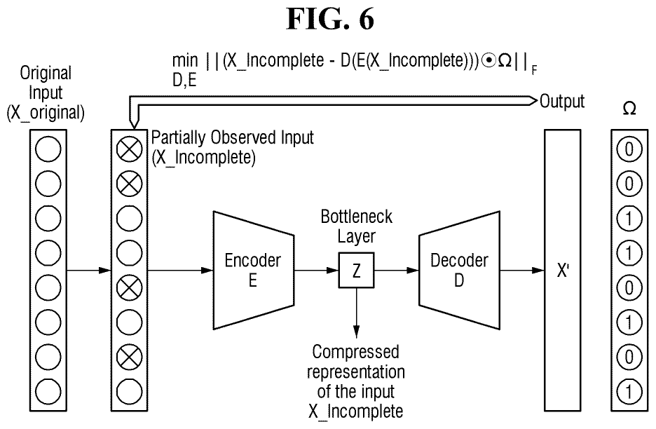

FIG. 6 is a diagram for illustrating an operation performed by the missing data processing module 322 according to some embodiments. FIG. 6 is a diagram schematically showing the self-supervised Hadamard autoencoder (SS-HAE).

The self-supervised Hadamard autoencoder (SS-HAE) is of a type of self-supervised learning technique and may be used to obtain a meaningful result in a situation where it is difficult for a deep learning model to know a correct answer during a process of learning the data.

Referring to FIG. 6, the missing data processing module 322 may intentionally generate a missing value X_Incomplete during the model learning process based on normal data X_original in consideration of MNAR, and the missing data processing module 322 may perform a learning process to gradually reduce an error between the substitute value X′ and the normal data X_original, where the substitute value X′ is estimated for the missing value by the self-supervised Hadamard autoencoder (SS-HAE) and the error is given by D(E(X_Incomplete).

Furthermore, the missing data processing module 322 may apply a Hadamard product to the self-supervised Hadamard autoencoder (SS-HAE) to process the missing value in a manner in which a weight Ω is applied to an estimating error relative to the normal data X_original about which a correct answer is known and is not applied to an estimating error relative to the missing value about which a correct answer is unknown in a learning process of the model. For example, a weight of ‘1’ may be given only to the estimating error relative to the normal data X_original about which a correct answer is known.

Furthermore, the missing data processing module 322 may acquire a substitute value for the missing value by performing interpolation on data of a sensor in which a missing value has occurred. The missing data processing module 322 may collect data from an individual sensor before/after a missing value occurs. Based on the premise that there is no sudden change in a state within a chamber connected to the sensor if the chamber is not subjected to the PM, the missing data processing module 322 may perform interpolation on the data collected from the individual sensor before/after the missing value occurs using linear regression or Gaussian process regression to acquire an estimated value. The missing data processing module 322 may employ the estimated value as the substitute value for the missing value.

The FDC sensor data (FDC in FIG. 2) may be collected as statistical values such as an average, a standard deviation, a minimum value range, and a maximum value range. Numerous sensors may be connected to one chamber. The FDC sensor data (FDC in FIG. 2) may have the statistical value varying depending on a recipe of the semiconductor manufacturing process performed in the chamber, even though the data is collected from the same sensor. Thus, it may be necessary to distinguish the varying statistical values for each recipe from each other.

In other words, the number of variables equal to the above-mentioned statistical values multiplied by the number of sensors and multiplied by the number of process recipes may be acquired in one process step. The semiconductor manufacturing process includes numerous process steps. Thus, numerous FDC sensor data (FDC in FIG. 2) may be collected per wafer.

It may be difficult to perform measurements on all of the wafers processed in a semiconductor manufacturing process due to limitations such as a turn-around time (TAT) required for the measurement and a cost of the measurement apparatus. Accordingly, in estimating the measurement value, the number of dependent variables (e.g., a measurement value on a pattern formed in the wafer, a wafer yield, etc.) may be very small, while the number of independent variables (e.g., the FDC sensor data, label-related data, incoming measurement data, etc.) to be considered may be very large.

That is, in the semiconductor manufacturing process measurement system according to some embodiments, in order to increase consistency in estimating the measurement value, there may be a need to select only significant independent variables.

The data selection module 323 may perform hybrid recursive feature selection (HRFS) in which inter-sensor correlation-based feature selection, feature importance-based recursive feature selection, and domain knowledge-based feature selection are performed together. In this regard, the domain knowledge may refer to expert knowledge possessed by engineers in a specific technical field.

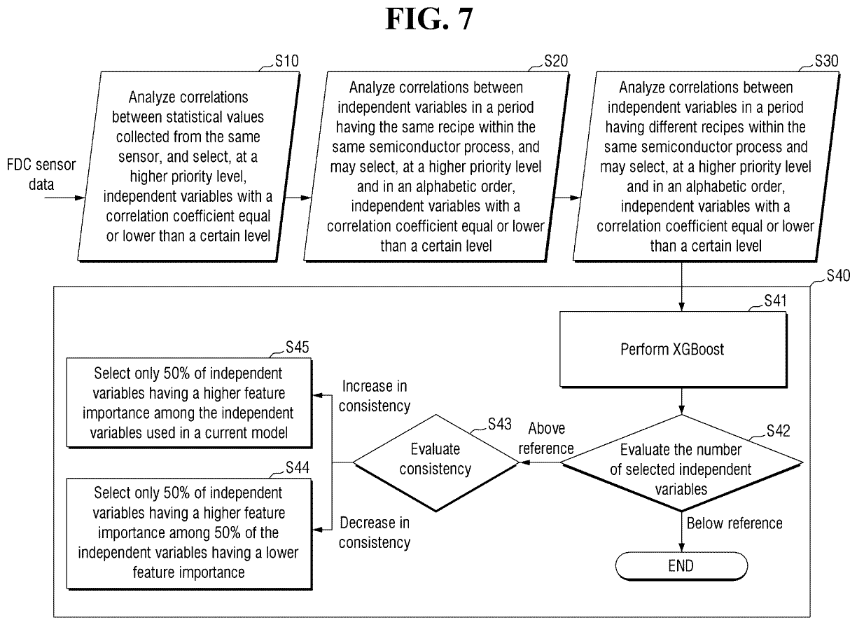

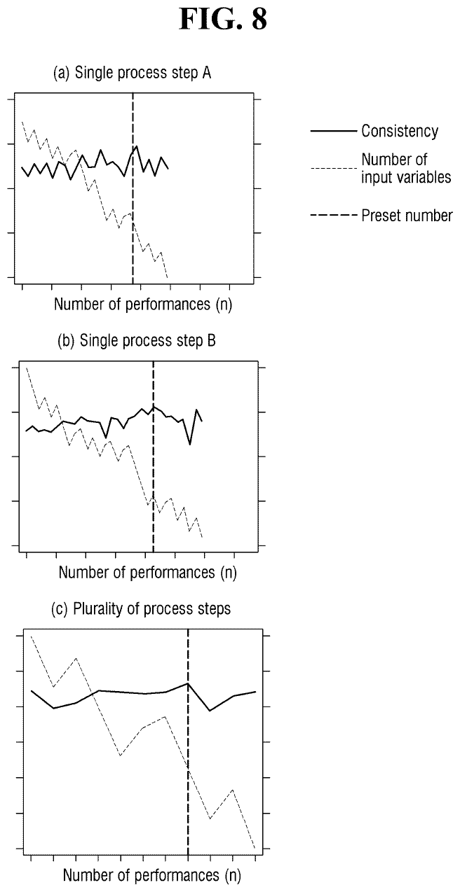

FIG. 7 and FIG. 8 are diagrams for illustrating an operation performed by the data selection module according to some embodiments. FIG. 7 is a diagram showing a hybrid recursive feature selection (HRFS) technique performed by the data selection module 323.

Referring to FIG. 7, in order to prevent occurrence of multicollinearity in which strong correlations between the independent variables occur, the data selection module 323 may analyze correlations between statistical values collected from the same sensor, and may select, at a higher priority level, independent variables with a correlation coefficient equal or lower than a certain level (e.g., 0.4) when calculating the statistical values (e.g., average, maximum, minimum, standard deviation) in S10.

In order to prevent occurrence of multicollinearity in which strong correlations between the independent variables occur, the data selection module 323 may analyze the correlation between the independent variables in a period having the same recipe within the same semiconductor manufacturing process, and may select, at a higher priority level and in an alphabetic order, independent variables with a correlation coefficient equal or lower than a certain level (e.g., 0.4) in S20.

In order to prevent occurrence of multicollinearity in which strong correlations between the independent variables occur, the data selection module 323 may analyze the correlation between the independent variables in a period having different recipes within the same semiconductor manufacturing process and may select, at a higher priority level and in an alphabetic order, independent variables with a correlation coefficient equal or lower than a certain level (e.g., 0.4) in S30.

By performing S10, S20, and S30, the data selection module 323 may ignore independent variables that are correlated with one another and only perform calculations for independent variables that are not correlated with one another. In some embodiments, other techniques may be performed to find independent variables that are not correlated with one another. For example, in some embodiments, only one or two of S10, S20, and S30 may be performed and/or other techniques may be performed in addition to S10, S20, and/or S30.

The data selection module 323 may apply an XGBoost algorithm as a type of a regression tree to all of the selected independent variables after the selection to perform the hybrid recursive feature selection (HRFS) in S40.

In this regard, the data selection module 323 may apply the XGBoost algorithm to all of the selected independent variables after the selection and calculate feature importance based on the application result. The data selection module 323 may also determine a value of the consistency of the selected independent variables. The data selection module 323 may select independent variables from the selected independent variables based on the calculated feature importance in S41 as calculated using the XGBoost algorithm.

The data selection module 323 may evaluate the quantity of the selected independent variables in S42 by comparing the quantity of the selected independent variables to a reference value.

Upon determination that evaluated number of the selected independent variables is greater than or equal to the reference value, the data selection module 323 may select a portion, such as the top 50%, of the selected independent variables having a higher feature importance from among the selected independent variables based on calculated feature importance. The data selection module 323 may the apply the XGBoost algorithm to the selected portion and may evaluate the consistency of the recursive feature selection model in S43. In some embodiments, the consistency may be represented as the standard deviation divided by the mean value with lower values indicating higher consistency.

When it is determined that that the consistency of the estimate measurement value obtained by performing the recursive feature selection (RFS) is lower than that of a model in an immediately previous step, the data selection module 323 may select only a portion, such as 50%, of the independent variables having a higher feature importance from among 50% of the independent variables having a lower feature importance (e.g., the top 50% of a remaining portion of the independent variables that were not selected previously by feature importance)., The data selection module 323 may add the selected portion of the independent variables having a lower feature importance to a current model and may apply the XGBoost algorithm thereto in S44.

When it is determined that the consistency of the estimate measurement value obtained by performing the recursive feature selection (RFS) is higher than that of the model in the immediately previous step, the data selection module 323 may select a portion, such as only 50%, of the independent variables having a higher feature importance from among the portion of the selected independent variables used in the current model. The data selection module 323 may the apply the XGBoost algorithm to the selected independent variables in S45.

The data selection module 323 may repeatedly apply the above-described steps S41 to S45 and terminate the recursive feature selection (RFS) when the quantity of the selected independent variables remaining in the model is smaller than or equal to a preset number (i.e., the reference value).

FIG. 8 is a diagram showing consistency of an estimated measurement value obtained by performing the recursive feature selection (RFS). Referring to each of (a) and (b) in FIG. 8, the above-mentioned variables may be selected from the perspective of each of single process steps A and B and a measurement process. Afterwards, referring to (c) in FIG. 8, the selection of the variables may be re-applied based on a combination of the selected independent variables from the perspective of a plurality of process steps and a measurement process.

Referring to FIG. 8, when the data selection module 323 has performed the recursive feature selection (RFS) on each of the single process step and the plurality of process steps n times, the consistency may be maintained at a time point at which the number of the variables equal or smaller than a preset number among the variables input to the model remain in the model.

Thus, only the minimum number of significant variables may be utilized while preventing decreases in the consistency as much as possible. Thus, not only a contribution of each of individual process steps (single process step A, single process step B), but also a contribution that can occur when the plurality of process steps are combined with each other in consideration of interactions between the process steps may be included into the estimating model. In other words, which process step among the plurality of process steps is more important, and which sensor among the plurality of sensors is more important may be intensively analyzed.

Furthermore, data from the sensor that is importantly monitored in the process step based on the domain knowledge may be additionally considered as an input variable to the model so as not to be affected by the above data-driven feature selection.

Like the FDC sensor data (FDC in FIG. 2), the incoming measurement data may be selected in consideration of the inter-sensor correlation and/or the inter-semiconductor manufacturing process correlation, and then the recursive feature selection (RFS) may be applied to the selected one.

In other words, the data selection module 323 may apply the above-described steps S10 to S30 to the incoming measurement data to perform the data selection, and then may apply the XGBoost algorithm to the selected data to perform the recursive feature selection (RFS) in S40.

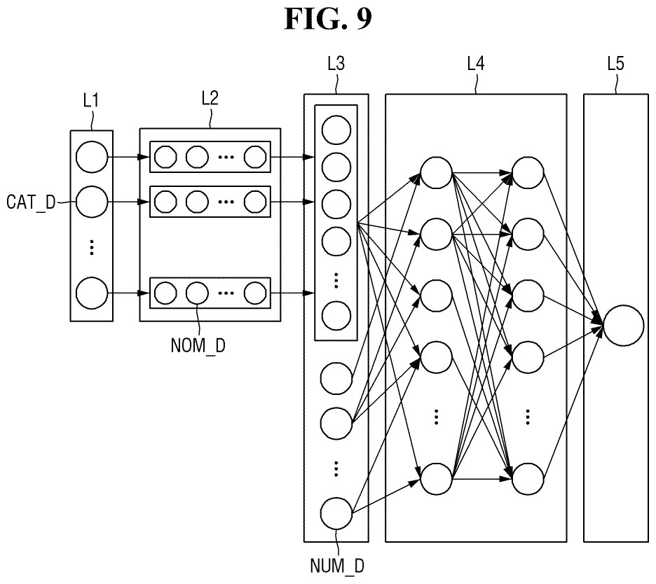

FIG. 9 is a diagram for illustrating an operation performed by the measurement value estimating module according to some embodiments.

The measurement value estimating module 330 may estimate a measurement value of a CD (Critical Dimension) or a thickness of a circuit pattern of the wafer or a wafer yield using the data collected in the semiconductor manufacturing process and processed, based on DNN (Deep Neural Network). However, the estimated measurement value according to some embodiments is not limited to the CD or the thickness of the circuit pattern of the wafer or the yield of the wafer.

The measurement value estimating module 330 may use not only the independent variables selected by performing the hybrid recursive feature selection (HRFS), but also categorical data CAT_D to improve the consistency in estimating the measurement value of the model. For example, the categorical data CAT_D may include apparatus label, data on progress of a preceding process (path data), information on a reticle used in the photo process, apparatus unit information in a CVD process, etc.

Therefore, from the perspective of data properties, numerical data NUM_D and nominal data NOM_D as a type of categorical data CAT_D may be present together. The measurement value estimating module 330 may utilize the DNN to effectively learn the numerical data NUM_D and the nominal data NOM_D and estimate the measurement value based on the learning result.

Referring to FIG. 9, the DNN may include an input layer L1, an embedding layer L2, a concatenate layer L3, a hidden layer L4, and an output layer L5.

The embedding layer L2 may map data to data in another format in one-to-one correspondence. For example, the embedding layer L2 may map the nominal data that cannot be measured numerically into the numerical data (e.g., a set vector of numbers). Thus, the embedding layer L2 may enable efficient processing and learning of the apparatus label, and data about the process progress (path data) as the nominal data about the semiconductor manufacturing process.

As there are many types of the FDC sensor data (FDC in FIG. 2), there are also many types of the nominal data. Thus, the embedding may need to be performed more efficiently. Accordingly, the measurement value estimating module 330 may design the embedding layer L2 so that learning is performed based on characteristics of the semiconductor manufacturing process.

For example, the measurement value estimating module 330 may design the embedding layer L2 such that the DNN can learn the nominal data NOM_D input to the current model is extracted from which layer and/or which process step. For example, the measurement value estimating module 330 may design the embedding layer L2 such that the DNN can learn whether the nominal data NOM_D input to the current model is extracted from a process step related to BEOL or from a process step related to MOL in an etching process. In another example, the measurement value estimating module 330 may design the embedding layer L2 such that the DNN can learn whether the nominal data NOM_D input to the current model is extracted from an etching process step of a first layer or a tenth layer in a vertical direction in an etching process.

In each hidden layer L4, a process of optimizing a hyperparameter may be performed using a learning rate, a dropout rate, an activation function, the number of hidden layers, the number of units nodes, whether batch normalization is performed, a loss function, etc. The hyperparameter may refer to a variable set in the model to implement an optimal training model.

The dropout rate may refer to an overfitting prevention technique that drops out a portion of the hyperparameter value to obtain a generalized result. The loss function may refer to a function that reduces a difference between an estimated value and an actual value during the learning process.

Accordingly, the measurement value estimating module 330 may apply Bayesian optimization to find the optimal hyperparameter. Thus, the measurement value estimating module 330 may define a function f(x) whose output value is the consistency between an input value and an estimated measurement value related to the hyperparameter, and the measurement value estimating module 330 may search for a combination that maximizes the output value of the function f(x) while changing the input value to the function f(x).

Using the Bayesian optimization, the measurement value estimating module 330 may compare the output values related to a combination of input variables at a time point t with each other and may find a combination of input variables at a time point t+1 using an acquisition function.

The Bayesian optimization may be introduced to achieve computational efficiency, and derive better hyperparameter combination, compared to grid search or random search. Further, the number of the hyperparameter combinations that may be searched for in a given problem environment is close to infinite. Thus, in some embodiments, a more optimized hyperparameter value may be derived by performing parallel computation using a computer device including multiple processors and multiple memories.

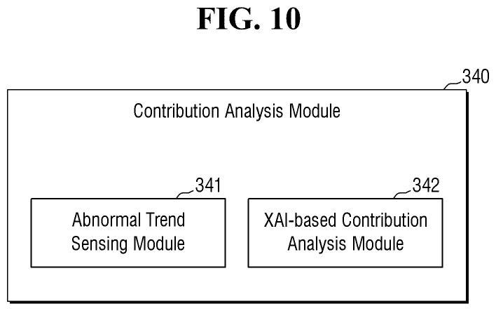

FIG. 10 is a diagram illustrating the contribution analysis module according to some embodiments.

The contribution analysis module 340 may include an abnormal trend sensing module 341 and an XAI-based contribution analysis module 342.

After the measurement values on all wafers have been estimated by the measurement value estimating module 330, the abnormal trend sensing module 341 may perform abnormality detection based on the trend of the estimated measurement values. The CD or the thickness of the wafer circuit pattern may be designed to have a target value depending on the process recipe. The closer the estimated measurement value is to the target value as possible, the more stable nominal characteristics may be. Therefore, if an upward or downward trend occurs when monitoring the measurement values in a chronological order, action should be taken.

To detect the trend, the abnormal trend sensing module 341 may use a MK test (Mann-Kendall test) to detect statistically significant trend change (for example, change in a slope of a trend line) of the estimated measurement values that are sequentially input. The MK test refers to a nonparametric test scheme and does not include an assumption about a distribution of a population. Therefore, the MK test is known to produce a result that is robust against a missing value, seasonality, an outlier, etc. (i.e., not sensitive to external environmental changes), and may statistically test monotonic upward/downward trend of the estimated measurement values.

Conventional measurement value monitoring typically detects change based on short-term data of about a day or a week. However, it is difficult to detect change over a long period of time via the short-term monitoring. The abnormal trend sensing module 341 according to some embodiments may perform the MK test to detect change in the trend of the estimated measurement values for a long-term (e.g., 90 days) of individual sensors or change in the trend of the estimated measurement values for a medium-term (e.g., 30 days) of individual chambers.

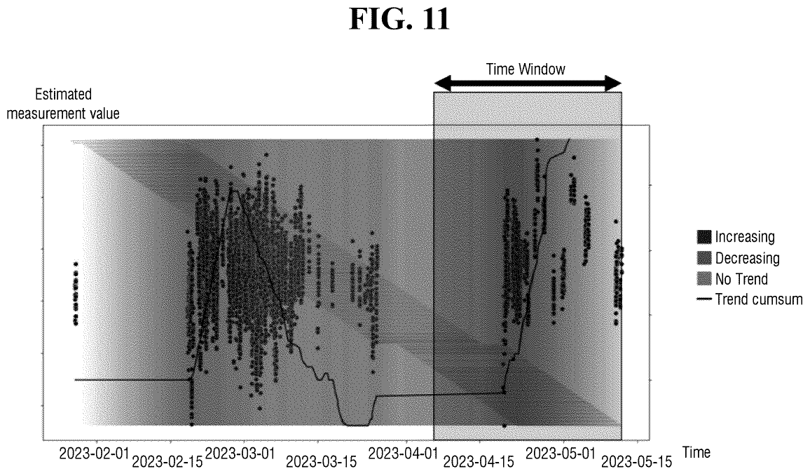

FIGS. 11 to 13 are diagrams illustrating an operation performed by the contribution analysis module 340 according to some embodiments.

FIG. 11 is a diagram showing a trend sensing process in which the abnormal trend sensing module 341 senses the trend of the estimated measurement values. FIG. 11 shows the trend sensing process in which data about the CD or the thickness of the pattern is used as the estimated measurement value.

The abnormal trend sensing module 341 may detect whether a trend of the long-term data is present, set a time window, and detect whether the trend is present while shifting the time window from the most recent to the past. Using the data within the time window, the trend from the past to the present may be determined. Thus, the abnormal trend sensing module 341 may determine whether the data in the time window have an increasing trend, a decreasing trend, or no trend.

For example, referring to FIG. 11, the data within the time window set for a period of about 30 days have an increasing trend. However, the set time window or the estimated measurement value is not limited to what is shown in FIG. 11.

In this process, the abnormal trend sensing module 341 may determine that an abnormal trend of the mid/long-term data is present when a trend identical to a long-term trend appears repeatedly.

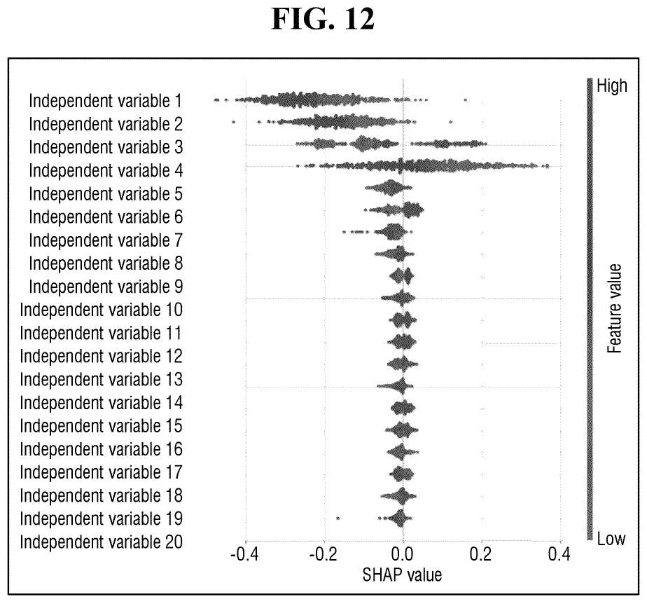

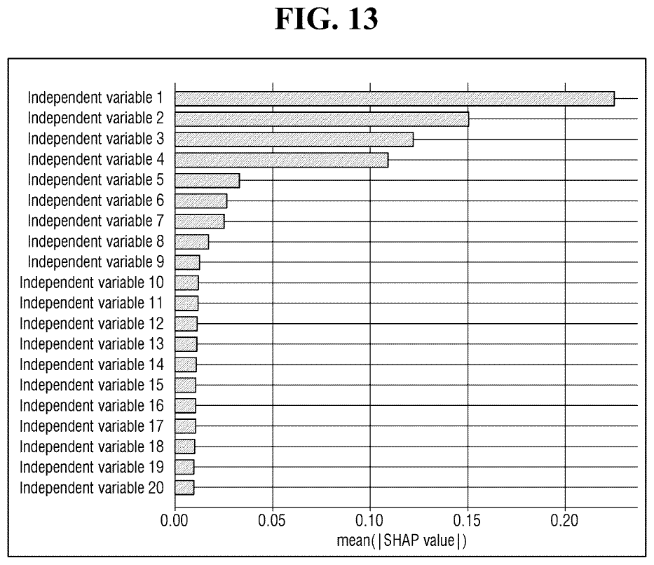

FIG. 12 and FIG. 13 are diagrams illustrating SHAP analysis of estimated measurement values performed by the XAI-based contribution analysis module 342.

If it is determined that a significant upward/downward trend of the estimated measurement values is present based on the MK test result, the XAI-based contribution analysis module 342 may identify input variables that have influenced the occurrence of the trend via Shapley value analysis. The SHAP analysis may mean calculating contributions of independent variables to each estimated measurement value using a Shapley value.

SHAP analysis may evaluate the change in the dependent variable based on change in the independent variable, regardless of a form of the estimating model, and may quantify the contribution of each independent variable based on this evaluated change. Therefore, an estimated measurement value determined to have a trend occurrence and an estimated value determined to have no trend occurrence may be compared with each other in an instance-wise manner, and the independent variable that causes a difference between the two estimated measurement values may be determined based on the comparing result.

Furthermore, the closer the Shapley value as the result of the SHAP analysis is to 0, the less the independent variable may affect the changes of the dependent variable or. If the Shapley value is close enough to 0, the independent variable may not affect the changes of the dependent variable. Therefore, the independent variables with a large absolute value of the Shapley value among the independent variables may be analyzed, and the independent variables that have a significant impact on the occurrence of the trend of the estimated measurement value may be determined based on the analysis result.

Referring to FIG. 12, the Shapley value may be expressed as both positive and negative numbers. The closer the Shapley value is to 0, the independent variable may have a more minor effect on the estimated measurement value, that is, the dependent variable. If the Shapley value of any independent variable is negative, this means that the estimated measurement value has decreased. As a high feature value is more dominant, this may mean that the estimated measurement value has decreased when the value of the independent variable is large.

Referring to FIG. 13, as an average value of the absolute value of the Shapley value is larger, it may be determined that the independent variable may more greatly contribute to the change in the value of the dependent variable.

The number of the independent variables, the Shapley value, and the average value of the absolute value of the Shapley value are not limited to those shown in FIG. 12 and FIG. 13.

The independent variable used in the semiconductor manufacturing process measurement system according to some embodiments may include the FDC sensor data, the apparatus label, the data about the progress of the preceding process (path data), and the incoming measurement data. In this regard, the contribution analysis module 340 may determine data that affects the trend of the estimated measurement value, based on the contribution of the individual independent variable as acquired through the SHAP analysis.

First, the average value of the absolute value of the Shapley value may be sorted in a descending order, and an independent variable with a high contribution may be selected based on the storing result. For example, when the selected variable is the FDC sensor data (FDC in FIG. 2), the sensor may be determined as a sensor that has directly influenced the dependent variable. Thus, the sensor and another FDC sensor cluster analyzed as having the high correlation therewith may be dealt with. When the selected variable is the apparatus label data, the apparatus may be determined as having a root cause. This may be dealt with via analysis of the FDC sensor data (FDC in FIG. 2) of the apparatus. When the selected variable is the incoming measurement data, the method may return to a previous measurement step and may deal therewith, such that the root cause may be sequentially identified.

Thus, a reliable estimated measurement value may be acquired using the semiconductor manufacturing process measurement system according to some embodiments. Furthermore, an explainable artificial intelligence (XAI: explainable AI) analysis technique based on the estimated measurement value may be introduced to identify a cause of the change in the estimated measurement value. In other words, a contribution by which the individual independent variable used in training any estimating model contributes to estimating of the value of the dependent variable may be expressed quantitatively, and a key management target variable may be selected based on an inter-independent variable contribution. Thus, more immediate apparatus/process management may be realized in the semiconductor manufacturing process with the long work time (TAT), and stable yield may be secured in each process.

The semiconductor manufacturing process measurement system according to some embodiments may be applied regardless of the characteristics of the process or a type of the measurement value estimating model. Accordingly, the semiconductor manufacturing process measurement system according to some embodiments may be widely applicable to an entire process for manufacturing the semiconductor device.

Furthermore, in the semiconductor manufacturing process measurement system according to some embodiments, factors affecting measurement value estimation may be ranked through SHAP analysis. Thus, the apparatus may be controlled in real time while identifying the fundamental factor affecting the measurement value estimation.

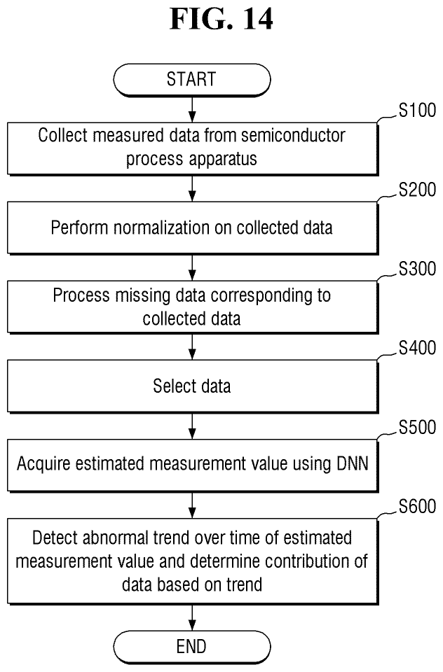

FIG. 14 is a flowchart for illustrating a semiconductor manufacturing process measurement method according to some embodiments. For convenience of description, the description of elements that would duplicate the descriptions as set forth above using FIG. 1 to FIG. 13 may be omitted.

Referring to FIG. 14, the data collection module 310 may collect measured data from the semiconductor manufacturing apparatus in S100.

The measured data collected from the semiconductor manufacturing apparatus may be, for example, the FDC sensor data (FDC in FIG. 2), the OES apparatus measurement data (OES in FIG. 2), and the wafer history data (EVENT in FIG. 2). However, embodiments of the present disclosure are not limited thereto.

The data normalization module 321 may perform normalization on the data in consideration of the characteristics of the semiconductor manufacturing apparatus in S200. For example, the normalization may be performed on the collected data in consideration of the PM cycle of the semiconductor manufacturing apparatus.

The missing data processing module 322 may acquire the estimated substitute value for the missing data corresponding to the collected data. For example, the missing data may be processed in consideration of the inherent characteristics of the semiconductor manufacturing apparatus in relation to the data in S300. The missing data processing module 322 may acquire the substitute value for the missing value based on the self-supervised Hadamard autoencoder (SS-HAE).

The data selection module 323 may select the key data from the collected data based on a correlation between semiconductor manufacturing processes in S400. The data selection module 323 may perform the hybrid recursive feature selection (HRFS) in which the inter-sensor correlation-based feature selection, the feature importance-based recursive feature selection (RFS), and the domain knowledge-based feature selection are performed together.

The measurement value estimating module 330 may acquire the estimated measurement value based on the DNN in S500. The measurement value estimating module 330 may perform efficient processing and learning of the apparatus label, and the data about the process progress (path data) as the nominal data about the semiconductor manufacturing process via the embedding layer (L2 in FIG. 10) configured to convert the categorical data into the numerical data.

The abnormal trend sensing module 341 may detect the abnormal trend over time of the estimated measurement value in S600. For example, the abnormal trend sensing module 341 may detect change in the trend of the estimated measurement value using the MK test.

The XAI-based contribution analysis module 342 may determine data affecting the abnormal trend of the estimated measurement value. For example, the XAI-based contribution analysis module 342 may calculate the contribution of the independent variables to each estimated measurement value via the Shapley value analysis. Thus, the contribution of the data to the occurrence of the abnormal trend may be determined in S600.

Although embodiments of the present disclosure have been described with reference to the accompanying drawings, embodiments of the present disclosure are not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above is not restrictive but illustrative in all respects.

What is claimed is:

1. A semiconductor manufacturing process measurement system comprising:
a memory; and
a processor configured to execute a program stored in the memory,
wherein the program is configured to be executed by the processor to cause the semiconductor manufacturing process measurement system to:
collect data from a semiconductor manufacturing apparatus;
preprocess the data in consideration of characteristics of the semiconductor manufacturing apparatus;
acquire an estimated measurement value using DNN (Deep Neural Network); and
detect a trend of the estimated measurement value over time and determine a contribution of the data based on the trend.

2. The semiconductor manufacturing process measurement system of claim 1, wherein the preprocessing, by the processor, of the data includes normalizing, by the processor, the data in consideration of a Predictive Maintenance (PM) cycle of the semiconductor manufacturing apparatus.

3. The semiconductor manufacturing process measurement system of claim 1, wherein the preprocessing, by the processor, of the data includes processing, by the processor, data to find missing values corresponding to the data using an autoencoder.

4. The semiconductor manufacturing process measurement system of claim 3, wherein the processor is further configured to:
generate a missing value corresponding to normal data;
acquire an estimated substitute value for the missing value; and
perform learning so as to minimize an error between the estimated substitute value for the missing value and the normal data.

5. The semiconductor manufacturing process measurement system of claim 1, wherein the preprocessing, by the processor, of the data includes selecting, by the processor, key data from among the data.

6. The semiconductor manufacturing process measurement system of claim 5, wherein the processor is further configured to:
select the data based on a correlation between sensors of the semiconductor manufacturing apparatus; and
perform recursive feature selection on the selected data, based on feature importance.

7. The semiconductor manufacturing process measurement system of claim 6, wherein the processor is further configured to select data having the correlation lower than or equal to a predefined level from among the data.

8. The semiconductor manufacturing process measurement system of claim 1, wherein the DNN includes an embedding layer configured to map nominal data about a semiconductor manufacturing process to numerical data.

9. The semiconductor manufacturing process measurement system of claim 1, wherein the processor is further configured to optimize a hyperparameter used in the DNN using Bayesian optimization.

10. The semiconductor manufacturing process measurement system of claim 1, wherein the processor is further configured to detect an abnormal trend of the estimated measurement value over time.

11. The semiconductor manufacturing process measurement system of claim 10, wherein the processor is further configured to determine data affecting the abnormal trend of the estimated measurement value via Shapley value analysis.

12. A semiconductor manufacturing process measurement system comprising:
a memory; and
a processor configured to execute a program stored in the memory,
wherein the program is configured to be executed by the processor to cause the semiconductor manufacturing process measurement system:
collect data measured by a sensor of a semiconductor manufacturing apparatus therefrom;
preprocess the data in consideration of characteristics of the semiconductor manufacturing apparatus;
acquire an estimated measurement value using DNN (Deep Neural Network); and
detect a trend of the estimated measurement value over time, and determine a contribution of the data based on the trend,
wherein the preprocessing, by the processor, of the data includes:
performing, by the processor, normalization of the data;
processing, by the processor, missing data corresponding to the data using an autoencoder; and
selecting, by the processor, key data from among the data.

13. The semiconductor manufacturing process measurement system of claim 12, wherein the processor is further configured to:
perform normalization of the data per each chamber of the semiconductor manufacturing apparatus; and
perform normalization of the data per each sensor of the semiconductor manufacturing apparatus.

14. The semiconductor manufacturing process measurement system of claim 12, wherein the processor is further configured to apply a weight to an estimating error relative to normal data and perform learning to minimize an error between an estimated substitute value for the missing value and the normal data.

15. The semiconductor manufacturing process measurement system of claim 12, wherein the processor is further configured to:
select data having a correlation between the sensors lower than or equal to a predefined value from among the data; and
perform recursive feature selection on the selected data.

16. The semiconductor manufacturing process measurement system of claim 12, wherein the DNN includes an embedding layer configured to map categorical data about a semiconductor manufacturing process to numerical data.

17. The semiconductor manufacturing process measurement system of claim 12, wherein the processor is further configured to perform MK (Mann-Kendall) test on the estimated measurement value and detect an abnormal trend based on a result of the MK test.

18. The semiconductor manufacturing process measurement system of claim 12, wherein the processor is further configured to analyze a Shapley value and determine data affecting the trend of the estimated measurement value based on a result of analyzing the Shapley value.

19. A semiconductor manufacturing process measurement system comprising:
a memory; and
a processor configured to execute a program stored in the memory,
wherein the program is configured to be executed by the processor to cause the semiconductor manufacturing process measurement system:
collect data measured from a semiconductor manufacturing apparatus;
perform normalization of the data in consideration of characteristics of the semiconductor manufacturing apparatus;
acquire an estimated substitute value for missing data corresponding to the data using an autoencoder;
select key data from the data based on a correlation between semiconductor manufacturing processes;
acquire an estimated measurement value using DNN (Deep Neural Network); and
detect an abnormal trend of the estimated measurement value over time and determining a contribution of the data based on the abnormal trend.

20. The semiconductor manufacturing process measurement system of claim 19, wherein the processor is further configured to determine data affecting the abnormal trend of the estimated measurement value via Shapley value analysis.
